(19) United States
(12) Patent Application Publication
(10) Pub. No.: US 2002/0197136 A1
(43) Pub. Date: Dec. 26, 2002

(54) Method and apparatus for aligning the loading/unloading of a wafer cassette to/from a loadport by an overhead hoist transport system

(75) Inventors: Yu-Chih Huang, Taichung City (TW); Annieson Tseng, Ziguan Town (TW); Michael Lan, Nantou City (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 09/886,760

(22) Filed: Jun. 21, 2001

(51) Int. Cl. B65G 1/133; B65G 1/00

(52) U.S. Cl. 414/217

(57) ABSTRACT

An apparatus and a method for aligning the loading/unloading of a wafer cassette to/from a loadport by an overhead hoist transport system are described. The apparatus utilizes a loadport that is equipped with at least two spaced-apart laser beam projectors mounted on a top surface of the loadport for projecting laser beams into a CCD array mounted on the bottom surface of the OHT rail facing the loadport. The actual position of the loadport can thus be continuously monitored and determined, and any necessary adjustment in positions of the OHT delivery arm for the wafer cassette can be made. A process controller is further provided for receiving the signal from the CCD array, or any other energy receiving means and for comparing to pre-stored data for sending a control signal to the OHT delivery arm.

### FIELD OF THE INVENTION

The present invention generally relates to an apparatus and a method for loading/unloading a wafer cassette onto/from a loadport and more particularly, relates to an apparatus and a method for aligning the loading/unloading of a wafer cassette onto/from a loadport by an overhead hoist transport system utilizing laser alignment.

### BACKGROUND OF THE INVENTION

In the manufacturing of a semiconductor device, the device is usually processed at many work stations or processing machines. The transporting or conveying of partially finished devices, or work-in-process (WIP) parts, is an important aspect in the total manufacturing process. The conveying of semiconductor wafers is especially important in the manufacturing of integrated circuit chips due to the delicate nature of the chips. Furthermore, in fabricating an IC product, a multiplicity of fabrication steps, i.e., as many as several hundred, is usually required to complete the fabrication process. A semiconductor wafer or IC chips must be transported between various process stations in order to perform various fabrication processes.

For instance, to complete the fabrication of an IC chip, various steps of deposition, cleaning, ion implantation, etching and passivation steps must be carried out before an IC chip is packaged for shipment. Each of these fabrication steps must be performed in a different process machine, i.e. a chemical vapor deposition chamber, an ion implantation chamber, an etcher, etc. A partially processed semiconductor wafer must be conveyed between various work stations many times before the fabrication process is completed. The safe conveying and accurate tracking of such semiconductor wafers or work-in-process parts in a semiconductor fabrication facility is therefore an important aspect of the total fabrication process.

Conventionally, partially finished semiconductor wafers or WIP parts are conveyed in a fabrication plant by automatically guided vehicles or overhead transport vehicles that travel on predetermined routes or tracks. For the conveying of semiconductor wafers, the wafers are normally loaded into cassettes pods, such as SMIF (standard machine interface) or FOUP (front opening unified pod), and then picked up and placed in the automatic conveying vehicles. For identifying and locating the various semiconductor wafers or WIP parts being transported, the cassettes or pods are normally labeled with a tag positioned on the side of the cassette or pod. The tags can be read automatically by a tag reader that is mounted on the guard rails of the conveying vehicle.

In an automatic material handling system (AMHS), stockers are widely used in conjunction with automatically guided or overhead transport vehicles, either on the ground or suspended on tracks, for the storing and transporting of semiconductor wafers in SMIF pods or in wafer cassettes. For instance, a stocker may be provided for controlling the storage and conveying of WIP wafers to three processing tools A, B and C. After a SMIF pod is delivered to one of the three tools, the SMIF pod is always returned to the stocker before it is sent to the next processing tool. In this process, only one stocker is required for handling three different processing tools and no buffer station is needed. The configuration illustrates that the frequency of use of the stocker is extremely high since the stocker itself is used as a buffer station for all three tools.

FIG. 1 illustrates a schematic of a typical automatic material handling system 20 that utilizes a central corridor 22, a plurality of bays 24 and a multiplicity of process machines 26. A multiplicity of stockers 30 are utilized for providing input/out to bay 24, or to processing machines 26 located on the bay 24. The central corridor 22 designed for bay lay-out is frequently used in an efficient automatic material handling system to perform lot transportation between bays. In this configuration, the stockers 30 of the automatic material handling system become the pathway for both input and output of the bay. Unfortunately, the stocker 30 frequently becomes a bottleneck for internal transportation.

In modern semiconductor fabrication facilities, especially for the 200 mm or 300 mm FAB plants, automatic guided vehicles (AGV) and overhead hoist transport (OHT) are extensively used to automate the wafer transport process as much as possible. The AGE and OHT utilize the input/output ports of a stocker to load or unload wafer lots, i.e. normally stored in POUFs. FIG. 2 is a perspective view of an overhead hoist transport system 32 consisting of two vehicles 34, 36 that travel on a track 38. An input port 40 and an output port 42 are provided on the stocker 30. As shown in FIG. 2, the overhead transport vehicle 36 stops at a position for unloading a FOUP 44 into the input port 40. The second overhead transport vehicle 34 waits on track 38 for input from stocker 30 until the first overhead transport vehicle 36 moves out of the way.

Similarly, the OHT system is also used to deliver a cassette pod such as a FOUP to a process machine. This is shown in FIG. 3. A cassette pod 10 of the FOUP type is positioned on a loadport 12 of a process machine 14. The loadport 12 is frequently equipped with a plurality of locating pins 16 for the proper positioning of the cassette pod 10. A detailed perspective view of the FOUP 10 is shown in FIG. 4. The FOUP 10 is constructed of a body portion 18 and a cover portion 28. The body portion 18 is provided with a cavity 46 equipped with a multiplicity of partitions 48 for the positioning of 25 wafers of the 300 mm size. The body portion 18 is further provided with sloped handles 50 on both sides of the body for ease of transporting. On top of the body portion 18, is provided with a plate member 52 for gripping by a transport arm (not shown) of an OHT system (not shown).

When an OHT system is utilized in transporting a cassette pod to a process machine, problems arise when the loadport of the process machine is not in alignment with the OHT system. Mis-positioned cassette pods on a loadport not only affects the operation of loading/unloading wafers from the pod, but also in severely misaligned causes may cause the cassette pod to tip over resulting in the breakage of wafers. Conventionally, manual adjustment is used to align the loadport of a process machine to an OHT system. This can be an extremely time consuming process which affects the yield.

It is therefore an object of the present invention to provide an apparatus for aligning the loading/unloading of a wafer cassette to/from a loadport by an overhead hoist transport system that does not have the drawbacks or shortcomings of the conventional apparatus.

It is another object of the present invention to provide an apparatus for aligning the load/unloading of a wafer cassette to/from a loadport by an overhead hoist transport system which detects the actual location of the loadport prior to such loading/unloading.

It is a further object of the present invention to provide an apparatus for aligning the load/unloading of a wafer cassette to/from a loadport by an overhead hoist transport system which utilizes laser beams for alignment.

It is another further object of the present invention to provide an apparatus for aligning the load/unloading of a wafer cassette to/from a loadport by an overhead hoist transport system that utilizes laser beam projectors mounted on the loadport and energy receiving means mounted on the OHT rail.

It is still another object of the present invention to provide an apparatus for aligning the load/unloading of a wafer cassette to/from a loadport by an overhead hoist transport system which utilizes at least two spaced-apart laser beam projectors mounted on the loadport and a CCD array mounted on the OHT rail.

It is yet another object of the present invention to provide a method for aligning the load/unloading of a wafer cassette to/from a loadport by an overhead hoist transport system by projecting at least two laser beams from the loadport onto the OHT rail for determining the actual location of the loadport prior to loading/unloading of the wafer cassette.

It is still another further object of the present invention to provide a method for aligning the load/unloading of a wafer cassette to/from a loadport by an overhead hoist transport system by first determining the location of the loadport by laser beams and then adjusting the position of an OHT delivery arm to correct the delivery position of the wafer cassette onto the loadport.

### SUMMARY OF THE INVENTION

In accordance with the present invention, an apparatus and a method for aligning the loading/unloading of a wafer cassette to/from a loadport by an overhead hoist transport system are provided.

In a preferred embodiment, an apparatus for aligning the loading/unloading of a wafer cassette to/from a loadport by an overhead hoist transport system is provided which includes a loadport positioned on a floor that has a top surface for mounting a wafer cassette thereto, the top surface of the loadport has at least two spaced-apart laser beam projectors for projecting at least two laser beams upwardly toward an OHT rail; an OHT rail positioned over the loadport that has a bottom surface facing the loadport, the bottom surface is equipped with an energy receiving means for receiving the at least two laser beams and for sending out a signal to a process controller to determine a position of the loadport; a process controller for receiving a signal from the energy receiving means and for comparing to pre-stored data for sending out a signal to an OHT delivery arm; and an OHT delivery arm for receiving a signal from the process controller to correct the delivery position of the wafer cassette onto the loadport based on the signal received.

In the apparatus for aligning the loading/unloading of a wafer cassette to/from a loadport by an OHT system, the loadport may be part of a semiconductor fabrication equipment. The OHT rail may be positioned over a plurality of loadports that are part of a plurality of process equipment aligned in an intra-bay of a fabrication facility. The energy receiving means may be an optical energy receiving means, or a CCD array. The OHT delivery arm may be a robotic arm, or may include a plurality of cables for holding and positioning a wafer cassette onto a loadport. The OHT delivery arm may be equipped with means for making rotational movement and linear movement to correct the delivery position of the wafer cassette.

The present invention is further directed to a method for aligning the loading/unloading of a wafer cassette to/from a loadport by an OHT system which includes the steps of positioning a loadport on a floor that has a top surface for mounting a wafer cassette thereto; mounting at least two spaced-apart laser beam projectors on the top surface of the loadport for projecting at least two laser beams upwardly toward an OHT rail; positioning an OHT rail over the loadport that has a bottom surface facing the loadport; mounting an energy receiving means on the bottom surface for receiving the at least two laser beams and for sending out a signal to a process controller to determine a position of the loadport; providing a process controller for receiving a signal from the energy receiving means and for comparing to pre-stored data to send out a signal to an OHT delivery arm; and adjusting the position of the OHT delivery arm based on the signal received from the process controller to correct the delivery position of the wafer cassette onto the loadport.

The method for aligning the loading/unloading of a wafer cassette to/from a loadport by an OHT system may further include the step of mounting an optical energy receiving means on the bottom surface of the OHT rail, or the step of mounting a CCD array on the bottom surface of the OHT rail. The method may further include the step of providing an OHT delivery arm in a robotic arm, or the step of providing an OHT delivery arm in a plurality of cables for holding and positioning a wafer cassette onto a loadport. The method may further include the step of adjusting the OHT delivery arm by rotational movement and linear movement. The method may further include the step of positioning the loadport in an intra-bay arrangement of a plurality of loadports each associated with a fabrication equipment.

### BRIEF DESCRIPTION OF THE DRAWINGS

These and other objects, features and advantages of the present invention will become apparent from the following detailed description and the appended drawings in which:

FIG. 1 is a schematic illustrating a conventional automatic material handling system utilizing a central corridor for intra-bay transport.

FIG. 2 is a schematic illustrating a conventional overhead hoist transport system for accessing a stocker.

FIG. 3 is a graph illustrating a cassette pod positioned on a loadport of a process machine.

FIG. 4 is a perspective view of a front opening unified pod FOUP).

FIG. 5 is a perspective view of a present invention OHT system and a loadport.

FIG. 6 is a bottom view of the present invention OHT rail illustrating the CCD array.

FIG. 7 is a side view of the present invention loadport, OHT rail and an OHT delivery arm.

FIG. 8 is a schematic illustrating the present invention CCD array connected to a CCD control unit.

FIG. 9 is a plane view of the present invention OHT rail and a plurality of process tools.

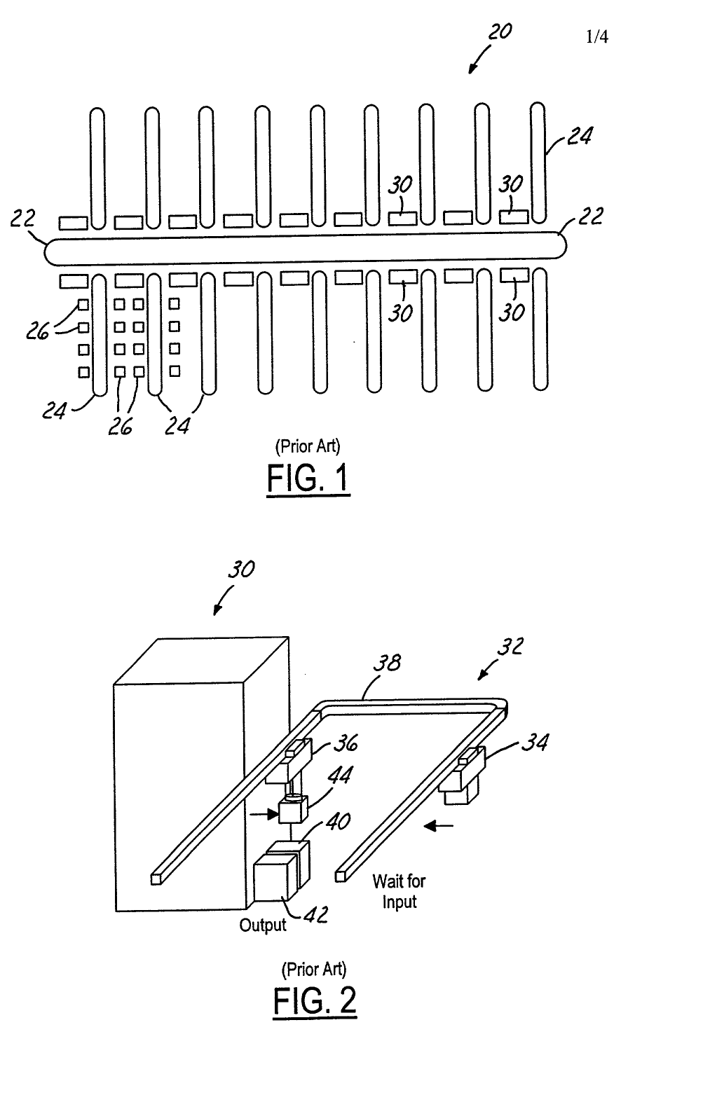

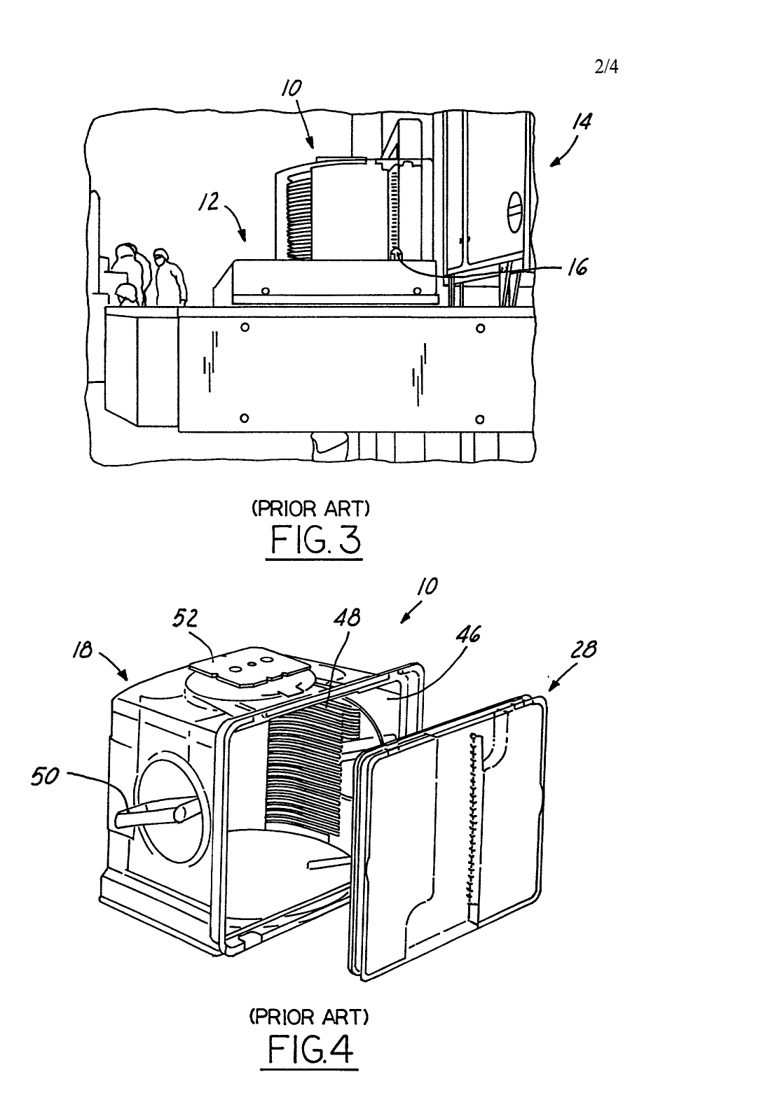

### DETAILED DESCRIPTION OF THE PREFERRED EMBODIMENT

The present invention discloses an apparatus and a method for aligning the loading/unloading operation of a wafer cassette, such as a FOUP to/from a loadport by an overhead hoist transport system.

The apparatus consists of a loadport that has at least two spaced-apart laser beam projectors mounted on a top surface for projecting at least two laser beams upwardly toward an OHT rail, and an OHT rail that has an energy receiving means mounted on a bottom surface facing the loadport for receiving the at least two laser beams and for sending a signal to a process controller to determine a position of the loadport.

The present invention novel apparatus provides a reliable means for the continuing monitoring of a loadport position relative to an OHT rail such that when an OHT delivery arm is used to deliver a wafer cassette to the loadport, any necessary adjustments in the positioning of the OHT delivery arm can be suitably made. The apparatus therefore allows the continuing monitoring and adjustment of an OHT delivery arm such that even when the position of the loadport is changed, such as during an earthquake or any other accidental movement of the process machine, the OHT delivery arm will automatically recognize the position change and adjust the arm position accordingly to precisely place a wafer cassette onto the loadport of the process machine.

In the preferred embodiment, two spaced-apart laser beam projectors are utilized for detecting the position of the loadport. However, any other detection device that operates on optical principles or sonic principles may be utilized in place of the laser beam projectors. Similarly, while in the preferred embodiment, a CCD array is mounted on the OHT rail as the energy receiving or detection means, any other energy receiving means can be suitably used on the OHT rail for detecting the position of the loadport by receiving and analyzing energy beams projected into and received by the detection means.

The present invention enables an automated method for exactly locating the loadport during a process tool start-up or during re-docking of the loadport for the fabrication facility that utilizes OHT system for transporting wafer cassettes. When the OHT rail is equipped with an energy receiving means and an OHT control unit, the actual position of the loadport can be recognized and determined by the OHT control unit and then sending signals to the OHT delivery arm such that the wafer cassette can be accurately positioned on the loadport.

In the present invention novel apparatus, two laser beam projectors are positioned on the top surface of the loadport and are located in the centerline of the loadport symmetrical to the centerline. Each of the laser beam projectors emits a vertical laser beam upwardly toward the OHT rail, i.e. toward the CCD array mounted on the bottom surface of the OHT rail. The centerline of the CCD array is located on the centerline of the OHT rail. When the CCD array receives two laser beams from the loadport, the CCD printed circuit board can accurately calculate the exact position of the loadport and send a signal to the OHT control unit, to exactly aim the cassette delivery arm during the loading/unloading of the wafer cassette.

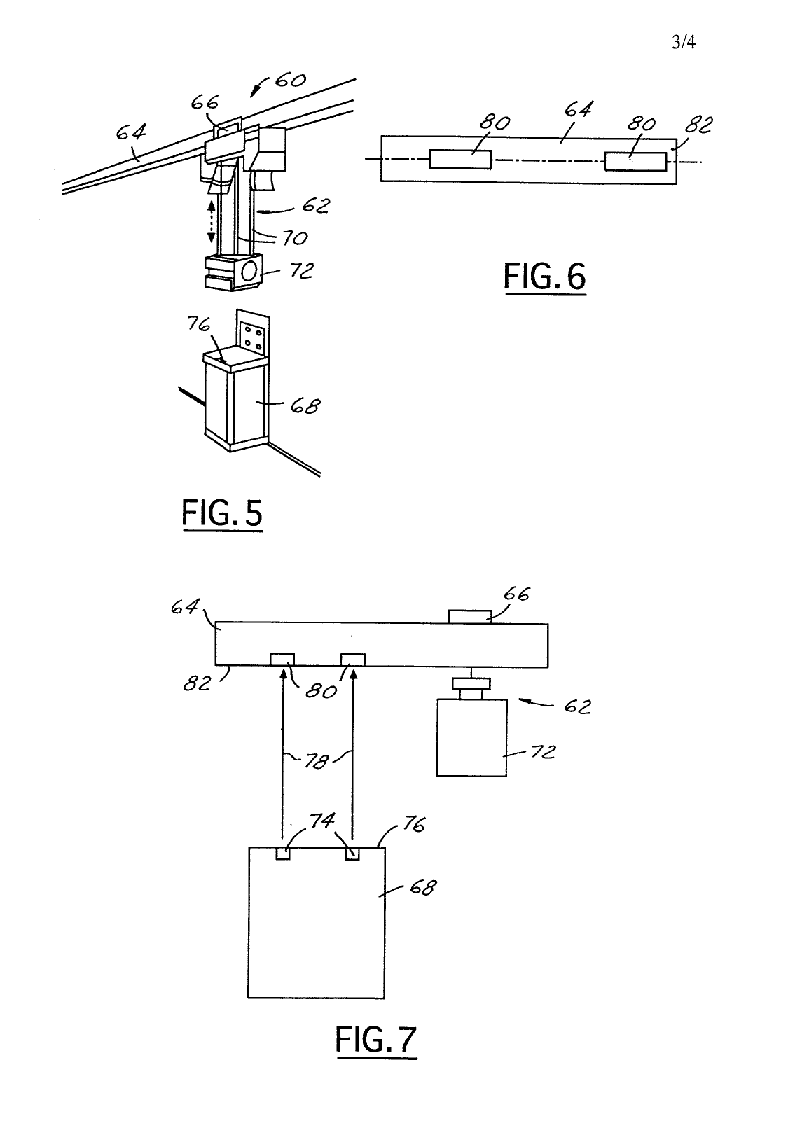

Referring now to FIG. 5, wherein a present invention apparatus 60 is shown that consists of an OHT delivery arm 62, an OHT rail 64, an OHT controller 66, and a loadport 68 attached to a process machine (not shown). As shown in FIG. 5, the OHT delivery arm 62 consists of a plurality of cables 70 for holding a wafer cassette 72, i.e. such as a FOUP.

The present invention laser beam projectors 74 are mounted in a top surface 76 of the loadport 68, as shown in FIG. 7. While two laser beam projectors 74 are shown in the preferred embodiment, any other combinations of the laser beam projectors, or any other energy beam projectors, may similarly be utilized. However, in order to accurately measure the position of the loadport 68, at least two of the energy beam projectors are required. The laser beam projectors 74 project a laser beam 78 toward a CCD array 80 which is mounted on the bottom surface 82 of the OHT rail 64. A bottom view of the CCD array 80 mounted in relation to the bottom surface 82 of the rail 64 is also shown in FIG. 6. It is seen that the CCD array 80 is mounted such that its centerline falls on the centerline of the OHT rail 64. As previously presented, any other type of energy receiving means, as long as it is possible to receive either an optical energy or sonic energy may also be utilized in place of the CCD array.

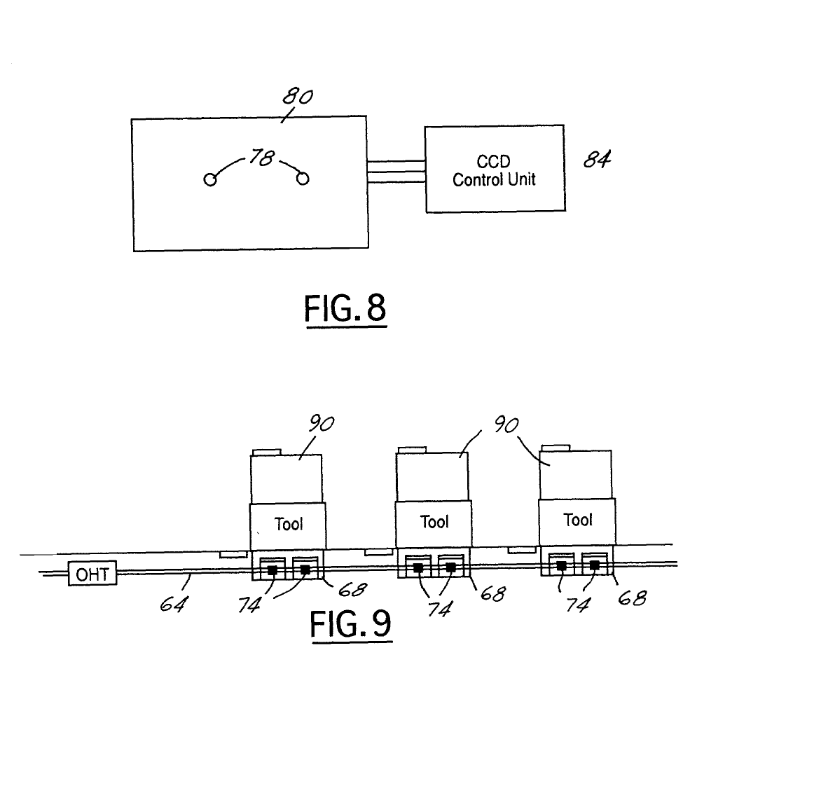

Also shown in FIG. 7, is an OHT delivery arm 62 which supports a wafer cassette, i.e. a FOUP 72. The OHT controller 66 is used to receive signals from the CCD control unit 84, as shown in FIG. 8, which in turn receives its signal from the CCD array 80. As shown in FIG. 8, the laser beams 78 are received on the CCD array 80 and thus signals are sent to the CCD control unit 84 for comparing with pre-stored data and for determining the position of the loadport 78. If the signals received are different than the pre-stored data, which indicates adjustments must be made to the OHT delivery arm 62, the CCD control unit 84 sends a signal to the OHT control unit 66 for making such adjustment.

The present invention apparatus can be utilized in a fabrication facility in a manner illustrated in FIG. 9. An OHT rail 64 is positioned over a plurality of process tools 90 each equipped with two laser beam projectors 74 on the loadport 68. In such a setup, the locations of the loadport 68 of all the plurality of process machines 90 can be continuously monitored during the operation of the fabrication facility and any corrections to the OHT delivery arm made when the loadport is accidentally moved out of its position. The present invention novel apparatus therefore prevents any accidental delivery of wafer cassette to a loadport in an incorrect position. As a result, any accidental tipping-over or breakage of wafers can be prevented.

While the present invention has been described in an illustrative manner, it should be understood that the terminology used is intended to be in a nature of words of description rather than of limitation.

Furthermore, while the present invention has been described in terms of a preferred embodiment, it is to be appreciated that those skilled in the art will readily apply these teachings to other possible variations of the inventions.

The embodiment of the invention in which an exclusive property or privilege is claimed are defined as follows.

What is claimed is:

1. An apparatus for aligning the loading/unloading of a wafer cassette to/from a loadport by an overhead hoist transport (OHT) system comprising:
a loadport positioned on a floor having a top surface for mounting a wafer cassette thereto, said top surface of the loadport having at least two spaced-apart laser beam projectors for projecting at least two laser beams upwardly toward an OHT rail;
an OHT rail positioned over said loadport having a bottom surface facing said loadport, said bottom surface being equipped with an energy receiving means for receiving said at least two laser beams and for sending out a signal to a process controller to determine a position of said loadport;
a process controller for receiving a signal from said energy receiving means and for comparing to pre-stored data for sending out a signal to an OHT delivery arm; and
an OHT delivery arm for receiving a signal from said process controller to correct the delivery position of said wafer cassette onto said loadport based on said signal received.

2. An apparatus for aligning the loading/unloading of a wafer cassette to/from a loadport by an OHT system according to claim 1, wherein said loadport is part of a semiconductor fabrication equipment.

3. An apparatus for aligning the loading/unloading of a wafer cassette to/from a loadport by an OHT system according to claim 1, wherein said OHT rail is positioned over a plurality of loadports that are part of a plurality of process equipment aligned in an intra-bay of a fabrication facility.

4. An apparatus for aligning the loading/unloading of a wafer cassette to/from a loadport by an OHT system according to claim 1, wherein said energy receiving means is an optical energy receiving means.

5. An apparatus for aligning the loading/unloading of a wafer cassette to/from a loadport by an OHT system according to claim 1, wherein said energy receiving means is a CCD array.

6. An apparatus for aligning the loading/unloading of a wafer cassette to/from a loadport by an OHT system according to claim 1, wherein said OHT delivery arm is a robotic arm.

7. An apparatus for aligning the loading/unloading of a wafer cassette to/from a loadport by an OHT system according to claim 1, wherein said OHT delivery arm comprises a plurality of cables for holding and positioning a wafer cassette onto a loadport.

8. An apparatus for aligning the loading/unloading of a wafer cassette to/from a loadport by an OHT system according to claim 1, wherein said OHT delivery arm being equipped with means for making rotational movement and linear movement to correct the delivery position of said wafer cassette.

9. A method for aligning the loading/unloading of a wafer cassette to/from a loadport by an OHT system comprising the steps of:
positioning a loadport on a floor having a top surface for mounting a wafer cassette thereto;
mounting at least two spaced-apart laser beam projectors on said top surface of the loadport for projecting at least two laser beams upwardly toward an OHT rail;
positioning an OHT rail over said loadport having a bottom surface facing said loadport;
mounting an energy receiving means on said bottom surface for receiving said at least two laser beams and for sending out a signal to a process controller to determine a position of said loadport;
providing a process controller to receive a signal from said energy receiving means and for comparing to pre-stored data to send out a signal to an OHT delivery arm; and
adjusting the position of said OHT delivery arm based on said signal received from said process controller to correct the delivery position of said wafer cassette onto said loadport.

10. A method for aligning the loading/unloading of a wafer cassette to/from a loadport by an OHT system according to claim 9 further comprising the step of mounting an optical energy receiving means on said bottom surface of the OHT rail.

11. A method for aligning the loading/unloading of a wafer cassette to/from a loadport by an OHT system according to claim 9 further comprising the step of mounting a CCD array on said bottom surface of the OHT rail.

12. A method for aligning the loading/unloading of a wafer cassette to/from a loadport by an OHT system according to claim 9 further comprising the step of providing an OHT delivery arm in a robotic arm.

13. A method for aligning the loading/unloading of a wafer cassette to/from a loadport by an OHT system according to claim 9 further comprising the step of providing an OHT delivery arm in a plurality of cables for holding and positioning a wafer cassette onto a loadport.

14. A method for aligning the loading/unloading of a wafer cassette to/from a loadport by an OHT system according to claim 9 further comprising the step of adjusting said OHT delivery arm by rotational movement and linear movement.

15. A method for aligning the loading/unloading of a wafer cassette to/from a loadport by an OHT system according to claim 9 further comprising the step of positioning said loadport in an intra-bay arrangement of a plurality of loadports each associated with a fabrication equipment.
